(19) United States
(12) Patent Application Publication
(10) Pub. No.: US 2005/0195900 A1
(43) Pub. Date: Sep. 8, 2005

(54) Video encoding and decoding methods and systems for video streaming service

(75) Inventor: Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/071,198

(22) Filed: Mar. 4, 2005

Related U.S. Application Data
(60) Provisional application No. 60/549,544, filed on Mar. 4, 2004.

(30) Foreign Application Priority Data
Apr. 24, 2004 (KR) 10-2004-0028487

(51) Int. Cl. H04N 7/12

(52) U.S. Cl. 375/240.21; 375/240.01; 375/240.12; 375/240.25

(57) ABSTRACT

Video encoding and decoding methods and systems for video streaming are provided. The video encoding method includes encoding first resolution frames using scalable video coding, upsampling the first resolution frames to a second resolution, and encoding second resolution frames using scalable video coding with reference to upsampled versions of the first resolution frames.

This application claims priority from Korean Patent Application No. 10-2004-0028487 filed on Apr. 24, 2004 in the Korean Intellectual Property Office and U.S. Provisional Application No. 60/549,544 filed on Mar. 4, 2004 in the United States Patent and Trademark Office, the entire disclosures of which are incorporated herein by reference.

### BACKGROUND OF THE INVENTION

1. Field of the Invention

The present invention relates to a video encoding method and system for video streaming services and a video decoding method and system for reconstructing the original video.

2. Description of the Related Art

With the development of information communication technology including the Internet, a variety of communication services have been newly proposed. One such communication service is a Video On Demand (VOD) service. VOD refers to a service in which a video content such as movies or news is provided to an end user over a telephone line, cable or Internet upon the user's request. Users are allowed to view a movie without having to leave their residence. Also, users are allowed to access various types of educational content via moving image lectures without having to physically go to a school or private educational institute.

Video streaming services, such as VOD, need to be provided with various resolutions, frame rates, or image qualities according to a network condition or the performance of a decoder. FIGS. 1A-1C respectively show conventional simulcast, multi-layer coding, scalable video coding schemes for video streaming at different resolutions, frame rates, or image qualities.

In the simulcast coding scheme, a separate bitstream is generated for each resolution, frame rate, or image quality. For example, three separate bitstreams are required in order to provide bitstreaming services at three resolutions. Referring to FIG. 1A, a video with 704×576 resolution (first resolution) and 60 Hz frame rate, a video with a 352×288 resolution (second resolution) and 30 Hz frame rate, and a video with 176×144 resolution (third resolution) and 15 Hz frame rate are independently encoded into three bitstreams. The first through third resolution bitstreams are respectively used for streaming services over networks capable of providing bandwidths of 6 Mbps, 750 Kbps, and 64 Kbps. A strong correlation exists between videos with different resolutions. The multi-layer coding scheme shown in FIG. 1B is one approach using a strong correlation between multi-layered video sequences.

In contrast to the simulcast coding scheme shown in FIG. 1A, the multi-layer coding scheme adopted by MPEG-2 for scalable video coding encodes a higher resolution enhancement layer video by referencing the lowest resolution base layer video. That is, referring to FIG. 1B, a first enhancement layer video with a 352×288 resolution is encoded with reference to an encoded base layer video with a 176×155 resolution, and a second enhancement layer video with a 705×576 resolution is encoded with reference to the first enhancement layer video.

Upon receipt of a user's request for the 705×576 resolution video, a streaming service provider transmits the video encoded in the second enhancement layer as well as the videos encoded in the first enhancement layer and the base layer to the user. The user that receives them first reconstructs the base layer video and then sequentially reconstructs the first enhancement layer video and the 705×576 resolution second enhancement layer video by referencing the reconstructed base layer video and the reconstructed first enhancement layer video, respectively.

Similarly, upon receipt of a user's request for the 352×288 resolution video, the streaming service provider transmits the videos encoded in the first enhancement layer and the base layer to the user. The user that receives them first reconstructs the base layer video and then reconstructs the first enhancement layer video with the 352×288 resolution by referencing the reconstructed base layer video. Upon receipt of a user's request for the 176×155 resolution video, the streaming service provider transmits the video encoded in the base layer to the user. The user then reconstructs the base layer video.

An example of a simulcast or multi-layer coding scheme has been disclosed in International Application No. PCT/US2000/09584. The application proposes a method for improving video coding efficiency by selectively using a simulcast or multi-layer coding scheme for scalable video coding. However, since this approach uses Discrete Cosine Transform (DCT)-based MPEG-4 as a basic coding algorithm, it does not offer sufficient scalability. That is, to provide video streaming services with n resolutions, this approach requires encoding of n video sequences or a video consisting of n layers. Conversely, a wavelet transform-based scalable video coding scheme enables video coding at different resolutions, frame rates, and image qualities using a single bitstream.

MPEG-4 intends to standardize scalable video coding that involves creating videos at various resolutions, frame rates, and image qualities from a single encoded bitstream. As shown in FIG. 1C, the scalable video coding scheme generates videos with various resolutions and frame rates from a single bitstream.

Spatial scalability that is the ability to generate videos with different resolutions from a scalable bitstream can be achieved with wavelet transform. Temporal scalability that is the ability to generate videos at different frame rates from a scalable bitstream can be provided by Motion Compensated Temporal Filtering (MCTF), Unconstrained MCTF (UMCTF), or Successive Temporal Approximation and Referencing (STAR). Signal-to-noise ratio (SNR) scalability can be achieved by embedded quantization.

Using a scalable video coding algorithm allows a video streaming service of a single bitstream obtained from a single video sequence at various resolutions and frames rates. However, such scalable video coding algorithms do not offer high quality bitstreams at all resolutions. In other words, conventional coding algorithms cannot provide for high quality bitstreams at all resolutions. For example, the highest resolution video can be reconstructed with high quality, but a low-resolution video cannot be reconstructed with satisfactory quality. More bits can be allocated for video coding of the low-resolution video to improve its quality. However, this will degrade the coding efficiency.

There is an urgent need for a video coding scheme for video streaming service designed to provide satisfactory image quality and high video coding efficiency by achieving a good trade-off between the coding efficiency and reconstructed image quality.

### SUMMARY OF THE INVENTION

The present invention provides a video encoding method and system capable of providing video streaming services with various image qualities and high coding efficiency.

The present invention also provides a video decoding method and system for decoding video encoded by the video encoding method and system to reconstruct an original video sequence.

According to an aspect of the present invention, there is provided a video encoding method comprising encoding first resolution frames using scalable video coding, upsampling the first resolution frames to a second resolution, and encoding second resolution frames using scalable video coding with reference to upsampled versions of the first resolution frames.

According to another aspect of the present invention, there is provided a video encoding method including encoding first resolution frames using non-scalable video coding, upsampling the first resolution frames to a second resolution, and encoding second resolution frames using scalable video coding with reference to upsampled versions of the first resolution frames.

According to still another aspect of the present invention, there is provided a video encoding method including encoding first resolution frames using scalable video coding, upsampling the first resolution frames to a second resolution, upsampling the first resolution frames to a third resolution, encoding second resolution frames using scalable video coding with reference to frames upsampled to the second resolution, and encoding third resolution frames using scalable video coding with reference to frames upsampled to the third resolution.

According to yet another aspect of the present invention, there is provided a video encoding method including encoding first resolution frames using scalable video coding, upsampling the first resolution frames to a second resolution, encoding second resolution frames using scalable video coding with reference to frames upsampled to the second resolution, encoding frames with a third resolution higher than the second resolution using scalable video coding, upsampling the third resolution frames to a fourth resolution, and encoding fourth resolution frames using scalable video coding with reference to frames upsampled to the fourth resolution.

According to a further aspect of the present invention, there is provided a video encoding method including encoding frames with a first resolution using scalable video coding, encoding frames with a second resolution higher than the first resolution using scalable video coding, independently of the first resolution frames, and encoding frames with a third resolution higher than the second resolution using scalable video coding, independently of the second resolution frames.

According to another aspect of the present invention, there is provided a video encoding method including encoding frames with a first resolution using non-scalable video coding, encoding frames with a second resolution higher than the first resolution using scalable video coding, independently of the first resolution frames, and encoding frames with a third resolution higher than the second resolution using scalable video coding, independently of the second resolution frames.

According to another aspect of the present invention, there is provided a video encoding method including encoding first resolution frames using scalable video coding, upsampling the first resolution frames to a second resolution, encoding frames with a third resolution higher than the second resolution using scalable video coding, downsampling the third resolution frames to the second resolution, and encoding second resolution frames using scalable video coding with reference to upsampled versions of the first resolution frames and downsampled versions of the third resolution frames.

According to another aspect of the present invention, there is provided a video encoding method including encoding second resolution frames using scalable video coding, downsampling the second resolution frames to a first resolution, and encoding first resolution frames using scalable video coding with reference to downsampled versions of the second resolution frames.

According to another aspect of the present invention, there is provided a video encoding method including encoding second resolution frames using scalable video coding, downsampling the second resolution frames to a first resolution, and encoding first resolution frames using non-scalable video coding with reference to downsampled versions of the second resolution frames.

According to another aspect of the present invention, there is provided a video encoding method including encoding third resolution frames using scalable video coding, downsampling the third resolution frames to a second resolution, encoding second resolution frames using scalable video coding with reference to frames downsampled to the second resolution, downsampling the third resolution frames to a first resolution lower than the second resolution, and encoding first resolution frames using scalable video coding with reference to frames downsampled to the first resolution.

According to another aspect of the present invention, there is provided a video encoder system including a first scalable video encoder encoding first resolution frames using non-scalable video coding, a second scalable video encoder converting the first resolution frames into a second resolution and encoding second resolution frames using scalable video coding with reference to the converted frames, and a bitstream generating module generating a bitstream consisting of the first resolution encoded frames and the second resolution encoded frames.

According to another aspect of the present invention, there is provided a video encoder system including a first scalable video encoder encoding frames with a first resolution using scalable video coding, a second scalable video encoder encoding frames with a second resolution lower than the first resolution using scalable video coding, and a bitstream generating module generating a bitstream consisting of the first resolution encoded frames and the second resolution encoded interframes.

According to another aspect of the present invention, there is provided a video encoder system including a scalable video encoder encoding frames with a first resolution using scalable video coding, a non-scalable video encoder encoding frames with a second resolution lower than the first resolution using non-scalable video coding, and a bitstream generating module generating a bitstream consisting of the first resolution encoded frames and the second resolution encoded interframes.

According to another aspect of the present invention, there is provided a video decoding method including decoding the first resolution frames encoded using scalable video coding to reconstruct original frames, upsampling the reconstructed first resolution frames to a second resolution, and decoding second resolution frames encoded using scalable video coding with reference to upsampled versions of the reconstructed first resolution frames in order to reconstruct original frames.

According to another aspect of the present invention, there is provided a video decoding method comprising decoding the first resolution frames encoded using non-scalable video coding to reconstruct original frames, upsampling the reconstructed first resolution frames to a second resolution, and decoding second resolution frames encoded using scalable video coding with reference to upsampled versions of the reconstructed first resolution frames in order to reconstruct original frames.

According to another aspect of the present invention, there is provided a video decoding method including decoding the first resolution frames encoded using scalable video coding to reconstruct original frames, downsampling some of the reconstructed first resolution frames to a second resolution and generating intraframes with the second resolution, and decoding second resolution interframes encoded using scalable video coding with reference to the generated intraframes.

According to another aspect of the present invention, there is provided a video decoding method including decoding the first resolution frames encoded using scalable video coding to reconstruct original frames, downsampling some of the reconstructed first resolution frames to a second resolution and generating intraframes with the second resolution, and decoding second resolution interframes encoded using non-scalable video coding with reference to the generated intraframes.

According to another aspect of the present invention, there is provided a video decoder system including a first scalable video decoder decoding first resolution frames encoded using scalable video coding in order to reconstruct original frames, and a second scalable video decoder converting the reconstructed first resolution frames to a second resolution and decoding second resolution frames encoded using scalable video coding with reference to the converted frames in order to reconstruct original frames.

According to another aspect of the present invention, there is provided a video decoder system including a non-scalable video decoder decoding first resolution frames encoded using non-scalable video coding in order to reconstruct original frames, and a scalable video decoder converting the reconstructed first resolution frames to a second resolution and decoding second resolution frames encoded using scalable video coding with reference to the converted frames in order to reconstruct original frames.

### BRIEF DESCRIPTION OF THE DRAWINGS

The above and other aspects of the present invention will become more apparent by describing in detail exemplary embodiments thereof with reference to the attached drawings in which:

FIGS. 1A-1C show conventional coding schemes for providing video streaming at different resolutions;

FIG. 2 illustrates a referencing relationship in encoding frames in an enhancement layer using a multi-layer coding scheme;

FIGS. 3A and 3B illustrate coding schemes for video streaming according to first and second exemplary embodiments of the present invention;

FIGS. 4A-4D illustrate coding schemes for video streaming according to third through sixth exemplary embodiments of the present invention;

FIGS. 5A-5D illustrate coding schemes for video streaming according to seventh through tenth exemplary embodiments of the present invention;

FIG. 6 illustrates a referencing relationship in interframe coding according to an exemplary embodiment of the present invention;

FIG. 7 illustrates a referencing relationship in interframe coding according to another exemplary embodiment of the present invention;

FIG. 8 illustrates a referencing relationship in interframe coding according to another exemplary embodiment of the present invention;

FIG. 9 illustrates a referencing relationship in interframe coding according to another exemplary embodiment of the present invention;

FIG. 10 illustrates sharing of an intraframe according to an exemplary embodiment of the present invention;

FIG. 11 illustrates sharing of an intraframe according to another exemplary embodiment of the present invention;

FIG. 12 is a block diagram of a video encoder system according to an exemplary embodiment of the present invention;

FIG. 13 is a block diagram of a video decoder system according to an exemplary embodiment of the present invention; and

FIG. 14 is a diagram for explaining a process of generating a smooth intraframe in a smooth enhancement layer in intraframe sharing and decoding a shared intraframe.

### DETAILED DESCRIPTION OF EXEMPLARY EMBODIMENTS OF THE INVENTION

The present invention will now be described more fully with reference to the accompanying drawings, in which preferred embodiments of the invention are shown.

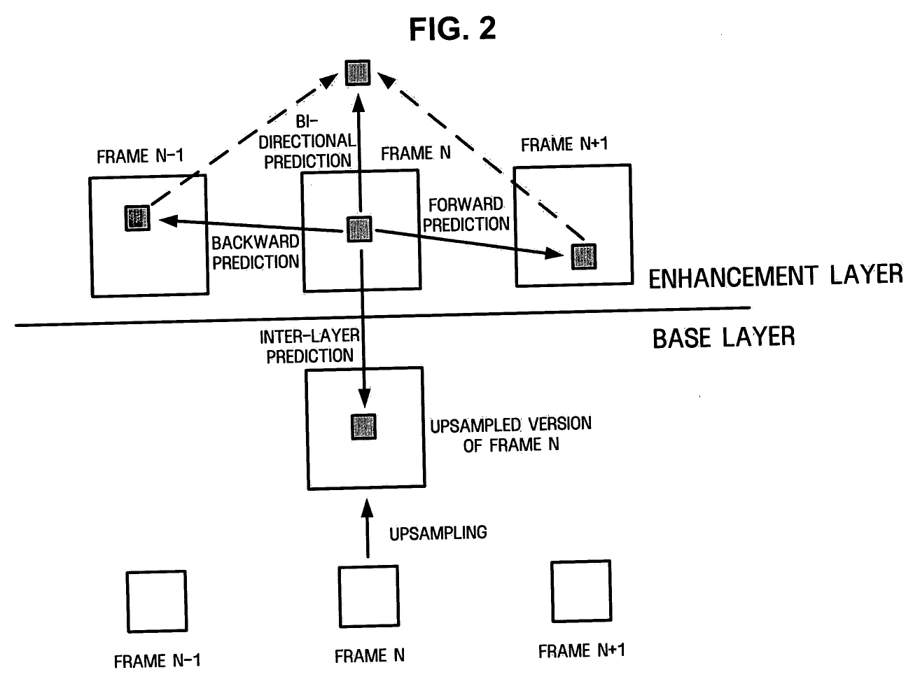

FIG. 2 illustrates a referencing relationship in encoding frames in an enhancement layer using a multi-layer coding scheme.

Referring to FIG. 2, a current frame (frame N) in the enhancement layer can be inter-coded using a previous frame (frame N−1) as a reference (backward prediction) or using a next frame (frame N+1) as a reference (forward prediction). When an average of one block in the previous frame and one block in the next frame is used as a reference, the prediction is called bi-directional prediction. In the multi-layer coding scheme, frames in the enhancement layer are encoded with reference to corresponding frames in the base layer, which is called inter-layer prediction.

The inter-layer prediction uses a current frame in a base layer to encode a current frame in an enhancement layer. A reference frame is created by upsampling or downsampling the current frame in the base layer to the resolution of the enhancement layer. For example, when the resolution of the base layer is lower than that of the enhancement layer as shown in FIG. 2, the current frame in the base layer is upsampled to the resolution of the enhancement layer and then the current frame in the enhancement layer is inter-coded with reference to an upsampled version of the frame in the base layer. When the resolution of the base layer is higher than that of the enhancement layer, the current frame in the base layer is downsampled to the resolution of the enhancement layer and the current frame in the enhancement layer is inter-coded with reference to a downsampled version of the frame in the base layer.

While all blocks in the enhancement layer frame are inter-coded based on one of the forward, backward, bi-directional, or inter-layer prediction modes, different prediction can be used for coding of each block. Weighted bi-directional prediction and intrablock prediction can also be used as a prediction mode. A prediction mode can be selected based on a cost containing the amount of coded data and the amount of motion vector data used for prediction, computational complexity, and other factors.

A frame in an enhancement layer may be encoded based on inter-layer prediction from another enhancement layer instead of a base layer. For example, a frame in a first enhancement layer may be encoded using a frame in a base layer as a reference, and a frame in a second enhancement layer may be encoded using the frame in the first enhancement layer as a reference. Furthermore, all or a part of frames in the first or second enhancement layer may be encoded based on inter-layer prediction using frames in another layer (the base layer or the first enhancement layer) as a reference. In particular, when the frame rate of a layer being referenced is lower than that of an enhancement layer currently being coded, some frames in the enhancement layer may be encoded based on prediction other than the inter-layer prediction.

Exemplary embodiments of the present invention use simulcast coding or multi-layer coding scheme to provide video streaming services at various resolutions and frame rates. The present invention also uses a scalable video coding scheme in all or part of layers to allow video streaming services at a larger number of resolutions and frame rates.

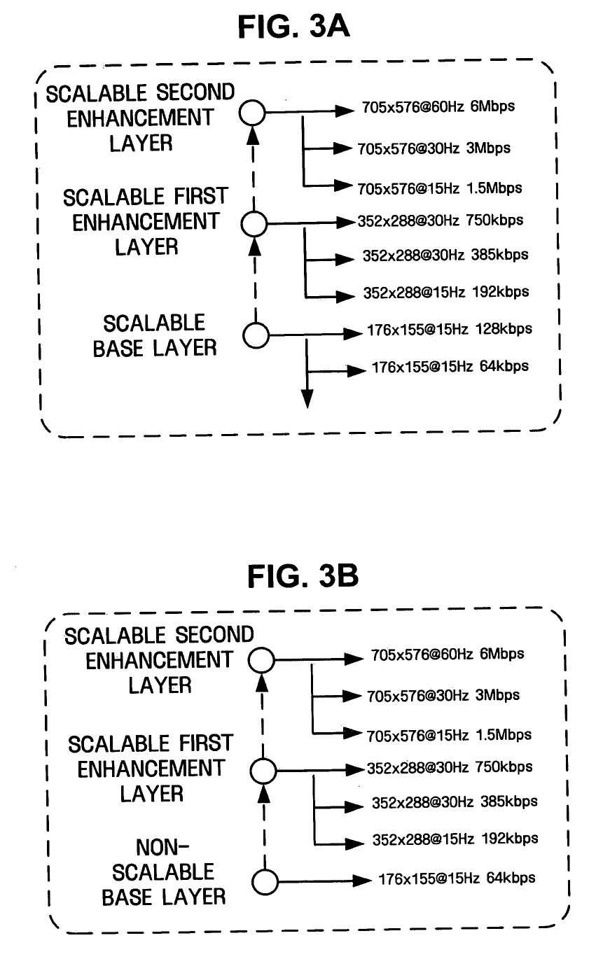

FIGS. 3A-5D illustrate coding schemes for video streaming according to first through tenth exemplary embodiments of the present invention. While a video is described to have three or four layers, the video may consist of two layers or five or more layers. Lower and upper layers in the first through tenth exemplary embodiments respectively denote lower- and higher-resolution layers. In FIGS. 3A-5D, inter-layer referencing is indicated by a dotted arrow, and videos with different resolutions, frame rates, or transmission rates that can be obtained from an encoded video in a certain layer are indicated by solid arrows.

FIG. 3A shows an example of a multi-layer coding scheme for video streaming according to a first exemplary embodiment of the present invention where video data is encoded into three layers, i.e., a base layer and first and second enhancement layers.

Referring to FIG. 3A, videos in all the layers are encoded using scalable video coding. That is, a video in the base layer is encoded using scalable video coding. A video in the first enhancement layer is encoded with reference to frames in the encoded base layer video using scalable video coding, and a video in the second enhancement layer is encoded with reference to frames in the encoded first enhancement layer video using scalable video coding.

Upon receiving a user's request for a 705×576 resolution video, a streaming service provider transmits the video encoded in the second enhancement layer as well as the videos encoded in the first enhancement layer and the base layer to the user. When a requested frame rate is 60 Hz, all frames encoded in the base layer and the first and second enhancement layers are transmitted to the user. On the other hand, when the requested frame rate is 30 or 15 Hz, the streaming service provider truncates unnecessary part of the coded frames before transmission. The user uses the coded frames to reconstruct the video in the base layer first. Then, the user sequentially reconstructs the video in the first enhancement layer and the 705×576 resolution video in the second enhancement layer by referencing the reconstructed video in the base layer and the reconstructed video in the first enhancement layer, respectively.

Upon receiving a user's request for a 352×288 resolution video, the streaming service provider transmits the videos encoded in the base layer and the first enhancement layer to the user. When a requested frame rate is 30 Hz, all frames encoded in the base layer and the first enhancement layer are transmitted to the user. On the other hand, when the requested frame rate is 15 Hz, the streaming service provider truncates unnecessary part of the coded frames before transmission. The user that receives the coded frames reconstructs the video in the base layer and then the 352×288 resolution video in the first enhancement layer by referencing the reconstructed video in the base layer.

Upon receipt of a user's request for a 176×155 resolution video, the streaming service provider transmits the video encoded in the base layer to the user. When the user selects bitstream transmission at a bit rate of 128 Kbps, all coded frames are transmitted to the user. However, when the user selects transmission at 64 Kbps, the streaming service provider truncates some bits of the coded frames before transmission. The user that receives the coded frames reconstructs the video in the base layer.

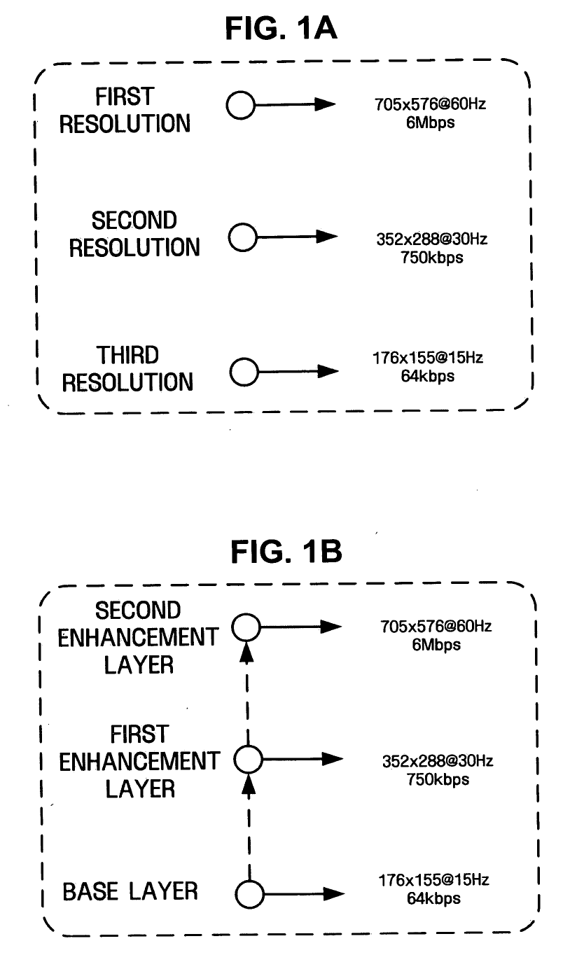

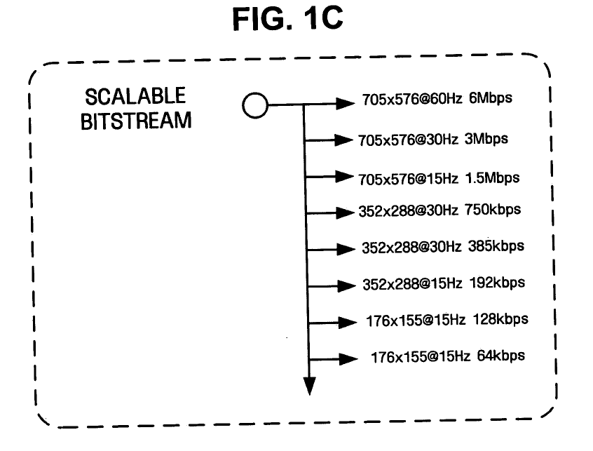

FIG. 3B shows an example of a multi-layer coding scheme for video streaming according to a second exemplary embodiment of the present invention, in which one layer is encoded using non-scalable video coding. While an H.264 or MPEG-4 video coding standard can support limited spatial scalability by using the coding schemes shown in FIG. 1 or limited temporal scalability as disclosed in International Application No. PCT/US2000/09584, it does not offer sufficient spatial, temporal, and signal-to-noise ratio (SNR) scalabilities.

Thus, the present invention uses a wavelet-based scalable coding scheme as a basic algorithm. While offering good spatial, temporal, and SNR scalabilities, currently known scalable video coding algorithms provide lower coding efficiency than H.264 or MPEG-4 . In order to improve coding efficiency, some layers can be encoded using a non-scalable H.264 or MPEG-4 scheme as shown in FIG. 3B.

Referring to FIG. 3B, the lowest resolution base layer is encoded using a non-scalable H.264 or MPEG-4 coding scheme since the lowest resolution video does not need to be scalable. That is, a video having a transmission rate of 64 Kbps (lowest bit rate) is encoded using the H.264 or MPEG-4 coding scheme with high coding efficiency.

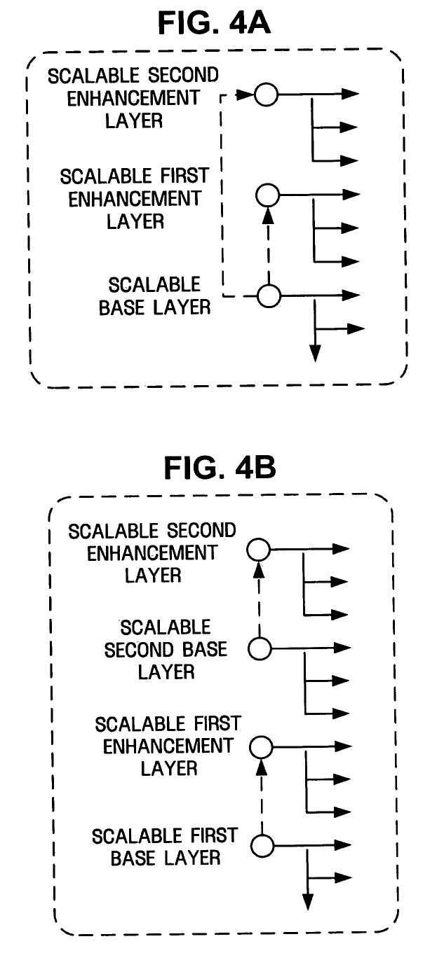

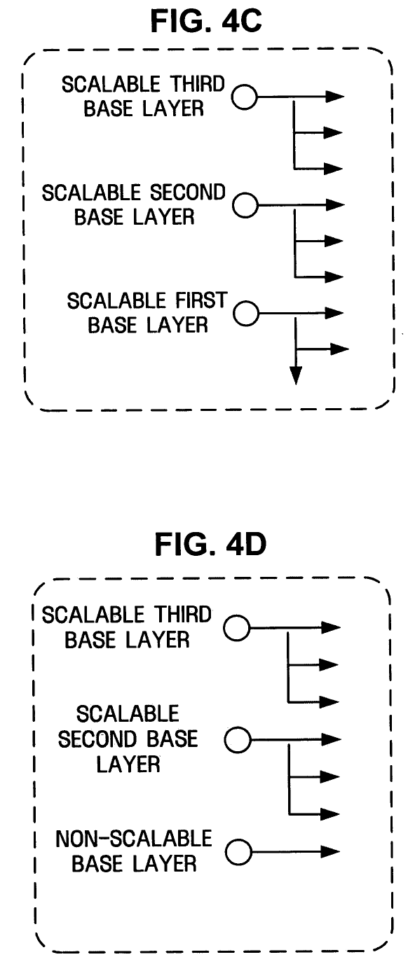

FIG. 4A shows an example of a multi-layer coding scheme for video streaming according to a third exemplary embodiment of the present invention, in which an enhancement layer is encoded with reference to a layer lower than the immediately preceding layer. In the third exemplary embodiment, a second enhancement layer is encoded with reference to a base layer instead of a first enhancement layer. The coding scheme according to the third exemplary embodiment provides lower coding efficiency than in the first exemplary embodiment because the second enhancement layer is encoded with reference to the base layer with a large resolution difference. However, it offers higher image quality than in the first exemplary embodiment since a video in the second enhancement layer is reconstructed by directly referencing the base layer instead of the first enhancement layer during a decoding process.

FIG. 4B shows an example of a multi-layer coding scheme for video streaming according to a fourth exemplary embodiment of the present invention, in which a video is encoded into a plurality of base layers and enhancement layers. Using many layers as in the first embodiment may degrade coding efficiency. Thus, in the fourth exemplary embodiment, a base layer that can be independently encoded without reference to any other layer is placed at a proper position determined according to the number of layers.

FIG. 4C shows an example of a simulcast video coding scheme according to a fifth exemplary embodiment of the present invention that uses only scalable coding in encoding each resolution. Depending on the type of application, a simulcast coding scheme is more efficient than a multi-layer coding scheme. When the simulcast coding scheme is more efficient, scalable video coding is used in encoding all or some of resolutions. Alternatively, to improve the coding efficiency, only the lowest resolution video may be encoded using non-scalable H.264 or MPEG-4 coding as in a sixth exemplary embodiment of FIG. 4D.

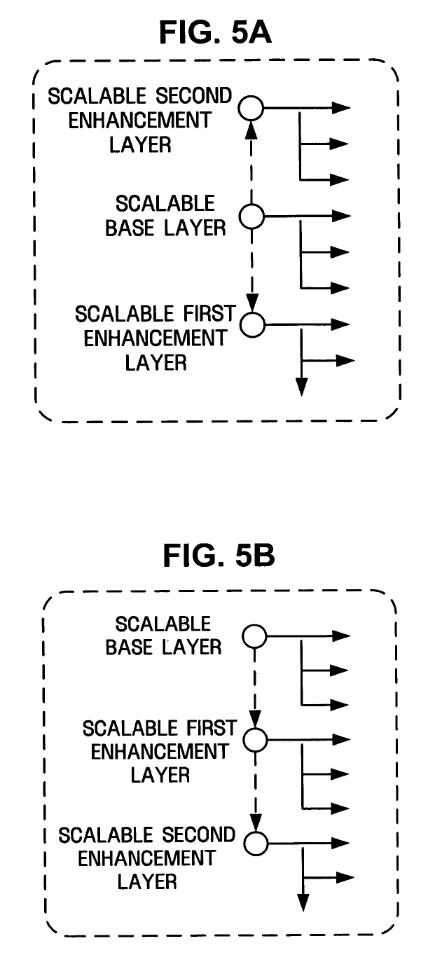

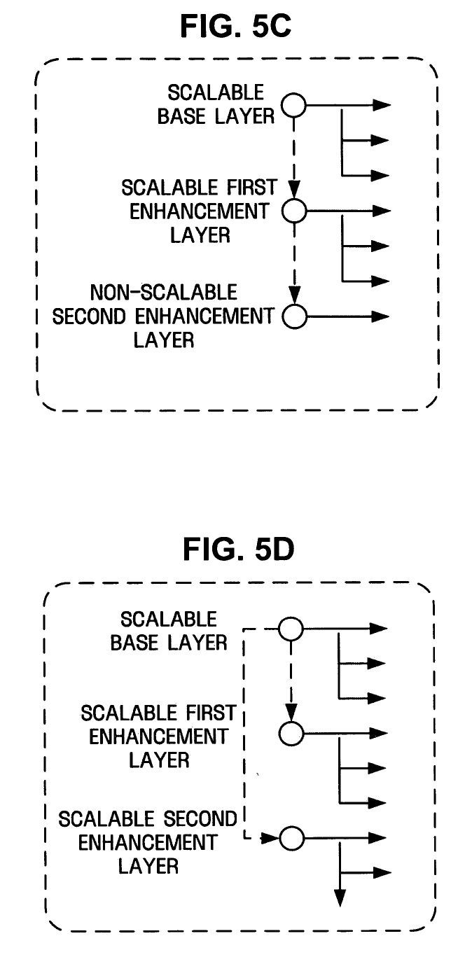

FIG. 5A shows an example of a multi-layer coding scheme for video streaming according to a seventh exemplary embodiment of the present invention in which the lowest resolution layer is not a base layer. In the multi-layer coding scheme, video data is encoded into the first enhancement layer of the lowest resolution, and the second enhancement layer of the highest resolution, by referencing intermediate resolution base layer. An upsampled version of a frame in the base layer is used as a reference in encoding a video in the second enhancement layer while a downsampled version of the frame in the base layer is used in encoding a video in the first enhancement layer.

FIG. 5B shows an example of a multi-layer coding scheme for video streaming according to an eighth exemplary embodiment of the present invention, in which a base layer is encoded at the highest resolution. In the eighth embodiment, a video in a first enhancement layer is encoded with reference to a video in the base layer, and a video in a second enhancement layer is encoded with reference to the video in the first enhancement layer. The reference frames used in encoding the first enhancement layer video are downsampled versions of frames in the base layer. Alternatively, to increase the coding efficiency, some of multiple layers can be encoded using a non-scalable video coding scheme as in a ninth exemplary embodiment shown in FIG. 5C.

FIG. 5D shows an example of a multi-layer video coding scheme for video streaming according to a tenth exemplary embodiment of the present invention. In contrast to the third exemplary embodiment shown in FIG. 4A, the multi-layer coding scheme in the tenth exemplary embodiment encodes a video in a lower-resolution layer with reference to a video in a high-resolution layer.

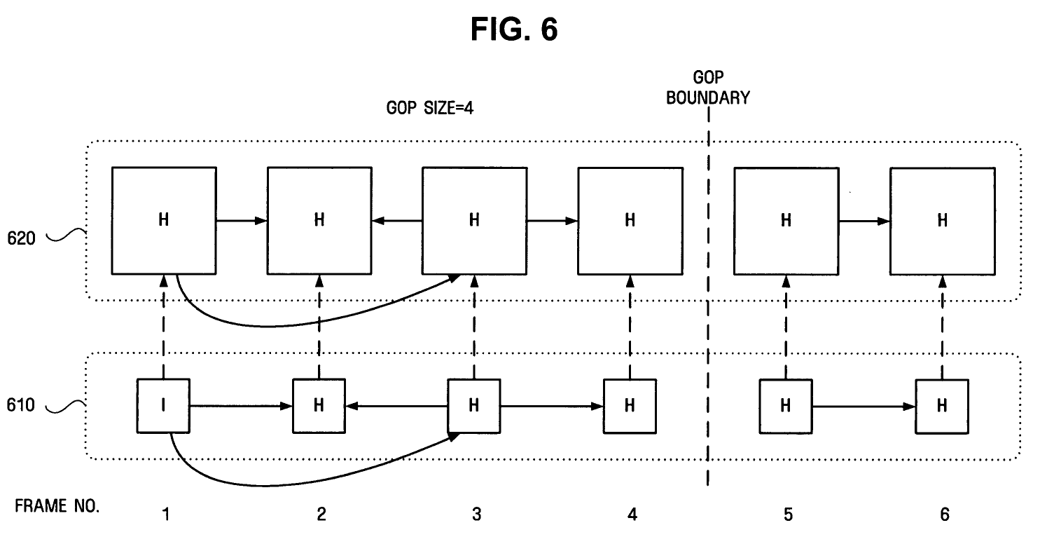

FIG. 6 illustrates a referencing relationship in interframe coding according to an exemplary embodiment of the present invention. Referencing between each resolution layer is indicated by dotted arrows while referencing within the same resolution layer is indicated by solid arrows.

Referring to FIG. 6, a low-resolution video 610 is encoded first. A coding order in the low-resolution video 610 is determined to achieve temporal scalability. That is, when the size of a group of pictures (GOP) is 4, frame 1 in the GOP is encoded as an intraframe (I frame) and frame 3 is encoded as an interframe (H frame). Then, the frames 1 and 3 are used as a reference to encode frame 2, and the frame 3 is used to encode frame 4. A decoding process is performed in the same order as the encoding process, i.e., according to the order of frames 1, 3, 2, and 4. After the frames 1, 3, 2, and 4 are sequentially decoded, the frames 1, 2, 3, and 4 are output in order.

A high-resolution video 620 is encoded with reference to the low-resolution video 610 in the same order as the low-resolution video 610, i.e., in the order of frames 1, 3, 2, and 4. To decode the high-resolution video 620, both encoded high- and low-resolution video frames are required. First, the frame 1 in the low-resolution video 610 is decoded, and the decoded frame 1 is used to decode frame 1 in the high-resolution video 620. Then, the frame 3 in the low-resolution video 610 is decoded, and the decoded frame 3 is used to decode frame 3 in the high-resolution video 620. Similarly, the frame 2 in the low-resolution video 610 is decoded and used in decoding frame 2 in the high-resolution video 620. The frame 4 in the low-resolution video 610 is decoded and used in decoding frame 4 in the high-resolution video 620, followed by decoding of frames in the next GOP. By encoding and decoding frames in this way, temporal scalability can be achieved. When a GOP size is 8, encoding and decoding are performed according to the order of frames 1, 5, 3, 7, 2, 4, 6, and 8. If only frames 1 and 5 are encoded or decoded, a frame rate is one-quarter the full frame rate. If only frames 1, 5, 3, and 7 are encoded or decoded, a frame rate is half the full frame rate.

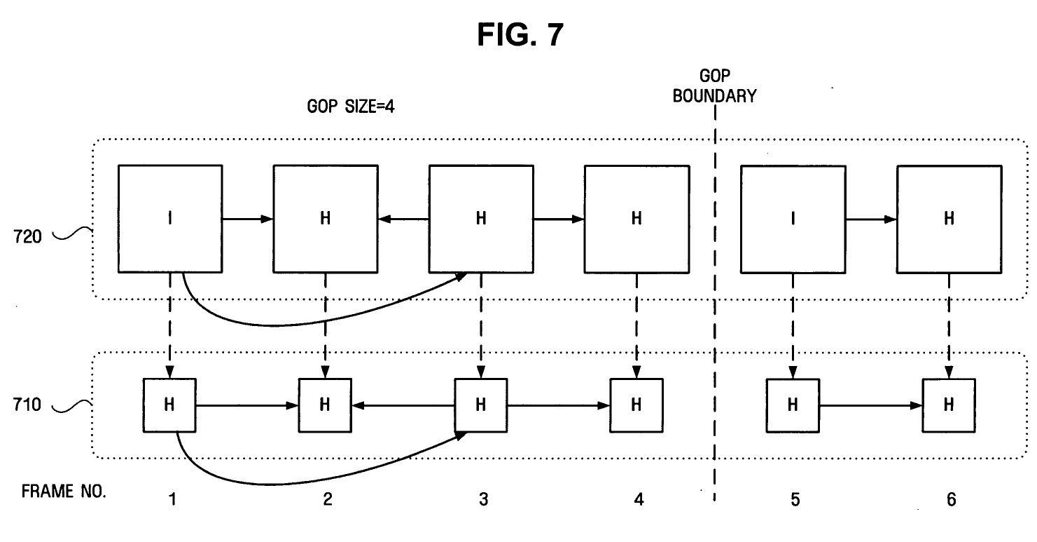

FIG. 7 illustrates a referencing relationship in interframe coding according to an exemplary embodiment of the present invention.

According to an exemplary embodiment shown in FIG. 6, the quality of the encoded low-resolution video is high since the frames 2 through 4 are encoded with reference to the I frame that can be encoded independently without reference to any other frame. On the other hand, the quality of the encoded high-resolution video is lower than that obtained when a simulcast coding scheme is used because the frames 2 through 4 are encoded with reference to the H frame that is encoded with reference to another frame. Thus, to address this problem, FIG. 7 shows an improved method for referencing between layers.

Referring to FIG. 7, a high-resolution video 720 is encoded first. A coding order in the high-resolution video 720 is determined to achieve temporal scalability. That is, when a GOP size is 4, frame 1 in the GOP is encoded as an intraframe (I frame) and frame 3 is encoded as an interframe (H frame). Then, the frames 1 and 3 are used as a reference to encode frame 2, and the frame 3 is used to encode frame 4. A decoding process is performed in the same order as the encoding process, i.e., according to the order of frames 1, 3, 2, and 4. After the frames 1, 3, 2, and 4 are sequentially decoded, the frames 1, 2, 3, and 4 are output in order.

A low-resolution video 710 is encoded with reference to the high-resolution video 720 in the same order as the high-resolution video 720, i.e., in the order of frames 1, 3, 2, and 4. To decode the low-resolution video 710, both encoded high- and low-resolution video frames are required. First, the frame 1 in the high-resolution video 720 is decoded, and the decoded frame 1 is used to decode frame 1 in the low-resolution video 710. Then, the frame 3 in the high-resolution video 720 is decoded, and the decoded frame 3 is used to decode frame 3 in the low-resolution video 710. In the same manner, the frame 2 in the high-resolution video 720 is decoded and used in decoding frame 2 in the low-resolution video 710. The frame 4 in the high-resolution video 720 is decoded and used in decoding frame 4 in the low-resolution video 710.

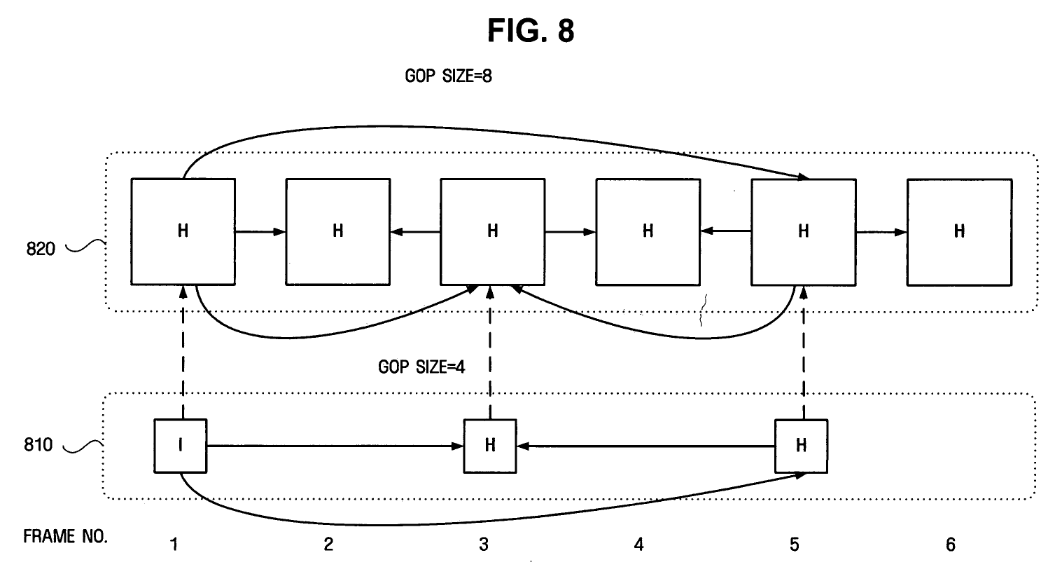

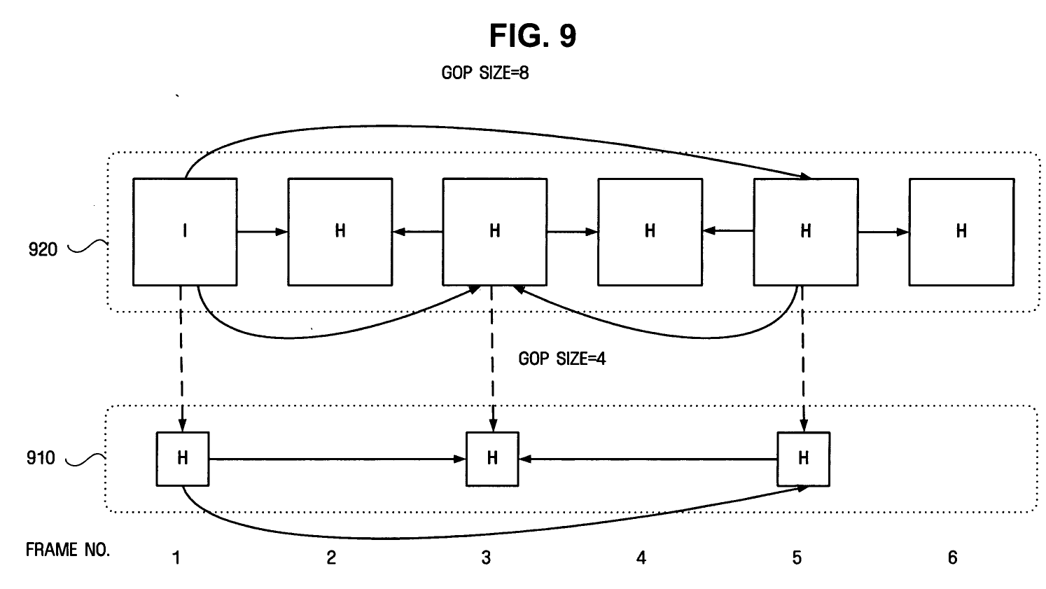

FIGS. 8 and 9 respectively illustrate referencing relationships in interframe coding according to other exemplary embodiments of the present invention when resolution layers have varying frame rates.

Referring to FIG. 8, a low-resolution video 810 is encoded first. A coding order in the low-resolution video 710 is determined to achieve temporal scalability. That is, when a GOP size is 4, frame 1 in the GOP is encoded as an intraframe (I frame) and frame 5 is encoded as an interframe (H frame). Then, the frames 1 and 5 are used to encode frame 3. In this way, frames 1, 5, 3, and 7 in the GOP are encoded in order. A decoding process is performed in the same order as the encoding process. On the other hand, a high-resolution video 820 is encoded with reference to the low-resolution video 810 in the same order as the low-resolution video 810, i.e., according to the order of frames 1, 5, 3, and 7. Then, frames 2, 4, 6, and 8 not contained in the low-resolution video 810 are encoded.

Referring to FIG. 9, a high-resolution video 920 is encoded first. A coding order in the high-resolution video 920 is determined to achieve temporal scalability. That is, when a GOP size is 8, all frames 1, 5, 3, 7, 2, 4, 6, and 8 in a GOP are sequentially encoded. A decoding process is performed in the same order as the encoding process. A low-resolution video 910 is encoded with reference to the high-resolution video 920 in the same order as the high-resolution video 920, i.e., in the order of frames 1, 5, 3, and 7.

While FIGS. 6-9 illustrate referencing relationships between two resolution layers according to the exemplary embodiments of the present invention, the illustrated embodiments can apply to a multi-layer video coding scheme as well, which encodes video data into three or more layers. In the case of video streaming services using a multi-layer video coding scheme in which a low-resolution frame is encoded with reference to a high-resolution frame, coding efficiency is reduced when a low-resolution bitstream is transmitted since the low-resolution bitstream contains low-resolution coded video data as well as high-resolution coded data. Simulcast video coding is more efficient for transmission of a low-resolution bitstream than multi-layer video coding.

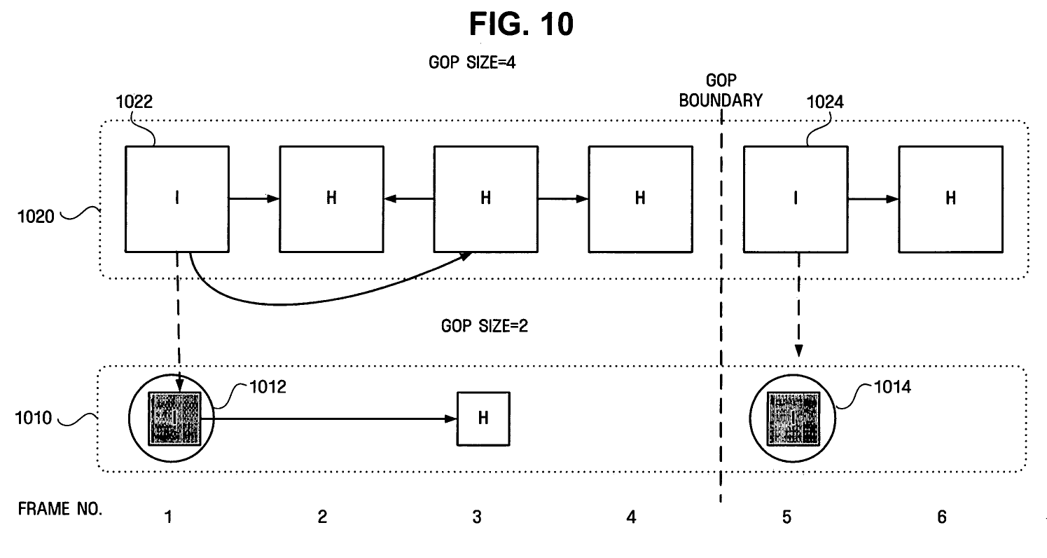

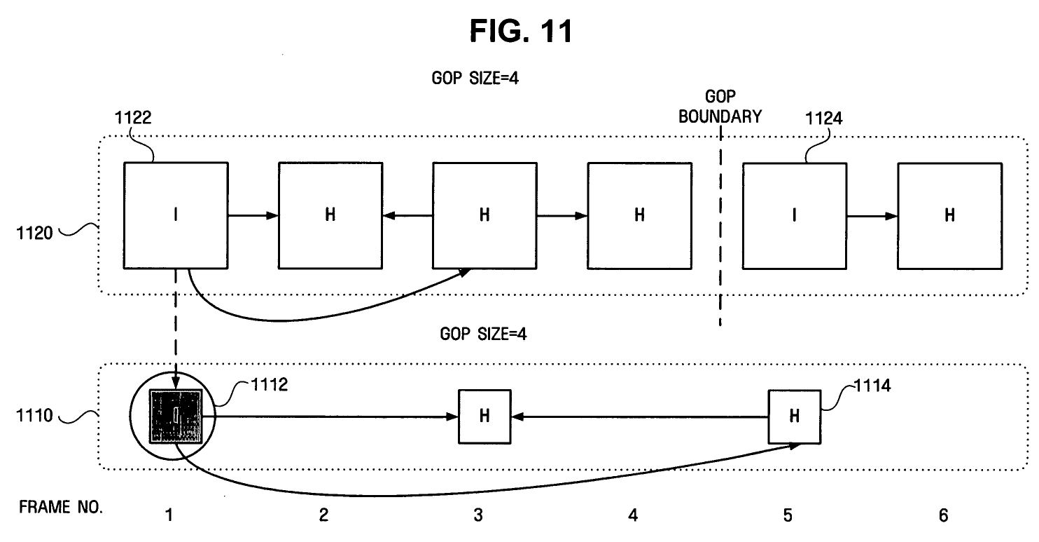

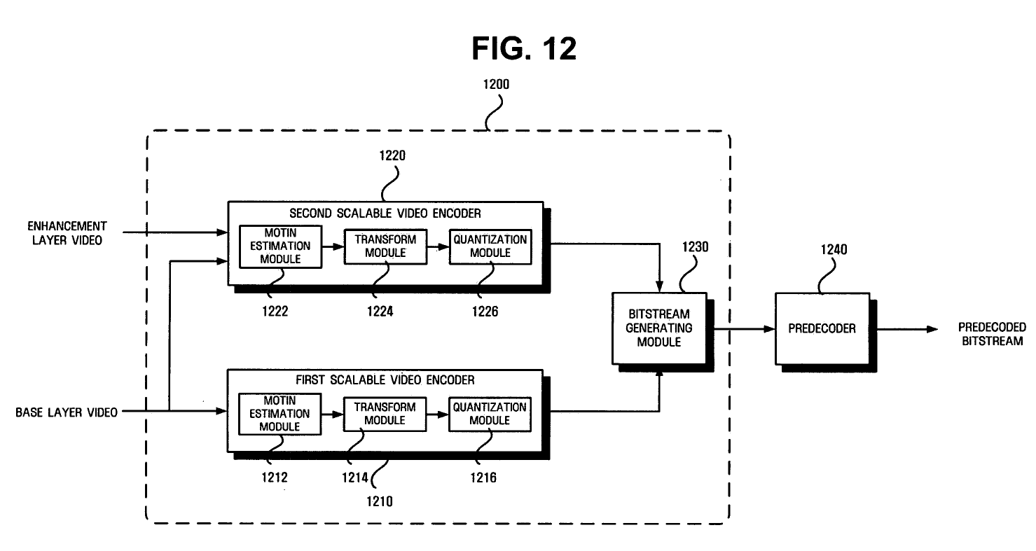

FIGS. 10 and 11 respectively illustrate sharing of an intraframe to improve coding efficiency in a simulcast video coding scheme to improve coding efficiency according to exemplary embodiments of the present invention.

Referring to FIG. 10, videos 1010 and 1020 with different resolutions are encoded independently using a simulcast coding scheme. The high-resolution video 1020 is encoded according to the order of frames 1, 3, 2, and 4 in order to achieve temporal scalability. The low-resolution video 1010 is also encoded according to an order that achieves temporal scalability. The encoded high- and low-resolution videos respectively include one intraframe (I frame) and one or more interframes (H frames) per GOP. In general, an I frame is allocated more bits than an H frame. Since the low-resolution video 1010 is quite similar to the high-resolution videos 1020 except for resolution, all frames in the low- and high-resolution videos 1010 and 1020 excluding low-resolution I frames 1012 and 1014 are encoded into a bitstream in the present exemplary embodiment. That is, the finally generated bitstream consists of all high-resolution encoded frames and low-resolution encoded interframes.

When a decoder requests for transmission of the high-resolution video 1020, the low-resolution encoded interframes in the bitstream are truncated and the remaining part is transmitted to the decoder. When the decoder requests for transmission of the low-resolution video 1010, the high-resolution encoded interframes are removed and unnecessary bits of high-resolution intraframes 1022 and 1024 shared with the low-resolution video 1010 are truncated to create the low-resolution intraframes 1012 and 1014, respectively. Then, a bitstream containing the low-resolution encoded interframes and the low-resolution intraframes 1012 and 1014 is transmitted to the decoder.

FIG. 11 illustrates sharing of an intraframe according to a another exemplary embodiment of the present invention.

Referring to FIG. 11, similar to the exemplary embodiment shown in FIG. 10, a high-resolution video 1120 shares an intraframe 1122 with a low-resolution video 1110. That is, for low-resolution video streaming, a low-resolution intraframe 1112 is created using the high-resolution intraframe 1122. However, the difference from the exemplary embodiment shown in FIG. 10 is that a high-resolution intraframe 1124 is not shared with the low-resolution video 1110 and a low-resolution frame 1114 is used an interframe. That is, when each resolution video has a different frame rate, it is possible to keep the percentage of I frames at a lower frame rate lower than at a high frame rate by making GOP sizes in the low- and high-resolution videos 1110 and 1120 equal instead of placing GOP boundaries to coincide with each other.

FIG. 12 is a block diagram of a video encoder system 1200 according to an exemplary embodiment of the present invention. While the video encoder system 1200 encodes video data into two layers with different resolutions, it may encode video data into n layers with different resolutions.

Referring to FIG. 12, the video encoder system 1200 includes a first scalable video encoder 1210 encoding a base layer video, a second scalable video encoder 1220 encoding an enhancement layer video, and a bitstream generating module 1230 that combines the encoded base layer video and enhancement layer video into a bitstream.

The first scalable video encoder 1210 receives the base layer video and encodes the same using scalable video coding. To accomplish this, the first scalable video encoder 1210 includes a motion estimation module 1212, a transform module 1214, and a quantization module 1216.

In order to remove temporal redundancies between frames in the base layer video, the motion estimation module 1212 estimates motion present between a reference frame and a current frame and produces a residual frame. Algorithms such as UMCTF or STAR are used to remove temporal redundancies using motion estimation. Some of the techniques described with reference to FIGS. 3-11 are selected for motion estimation to achieve a better trade-off between coding efficiency and image quality.

The transform module 1214 performs wavelet transform on the residual frame to produce transform coefficients. In the wavelet transform, a residual frame is decomposed into four portions, and a quarter-sized image (L image) that is similar to the entire image is placed in the upper left portion of the frame while information (H image) needed to reconstruct the entire image from the L image is placed in the other three portions. In the same way, the L image may be decomposed into a quarter-sized LL image and information needed to reconstruct the L image.

The quantization module 1216 applies quantization to the transform coefficients obtained by the wavelet transform. Currently known embedded quantization algorithms include Embedded Zerotrees Wavelet Algorithm (EZW), Set Partitioning in Hierarchical Trees (SPIHT), Embedded Zero Block Coding (EZBC), Embedded Block Coding with Optimized Truncation (EBCOT), and so on.

The second scalable video encoder 1220 receives the enhancement layer video and encodes the same using scalable video coding. To accomplish this, the second scalable video encoder 1220 includes a motion estimation module 1222, a transform module 1224, and a quantization module 1226.

In order to remove temporal redundancies between frames in the enhancement layer video, the motion estimation module 1222 estimates motion present between a frame current being encoded and reference frames in the enhancement layer video and the base layer video and obtains a residual frame. Algorithms such as UMCTF or STAR are used to remove temporal redundancies using motion estimation.

The transform module 1224 performs wavelet transform on the residual frame to produce transform coefficients. In the wavelet transform, a residual frame is decomposed into four portions, and a quarter-sized image (L image) that is similar to the entire image is placed in the upper left portion of the frame while information (H image) needed to reconstruct the entire image from the L image is placed in the other three portions. In the same way, the L image may be decomposed into a quarter-sized LL image and information needed to reconstruct the L image.

The quantization module 1226 applies quantization to the transform coefficients obtained by the wavelet transform. Currently known embedded quantization algorithms include EZW, SPIHT, EZBC, EBCOT, and so on.

The bitstream generating module 1230 generates a bitstream containing base layer frames and enhancement layer frames encoded by the first and second scalable video encoders 1210 and 1220 and corresponding header information.

In another exemplary embodiment, the video encoder system includes a plurality of video encoders encoding different resolution videos. Some of the plurality of video encoders use non-scalable video coding schemes such as H.264 or MPEG-4.

The generated bitstream is predecoded by a predecoder 1240 and then sent to a decoder (not shown).

The predecoder 1240 may be located at different positions depending on the type of video streaming services. In one embodiment, when the predecoder 1240 is incorporated into the video encoder system 1200 for video streaming, the video encoder system 1200 transmits only a predecoded bitstream to the decoder, instead of the entire bitstream generated by the bitstream generating module 1230. In another exemplary embodiment, when being located separately from the video encoder system 1200 but within a streaming service provider, the streaming service provider predecodes a bitstream encoded by a content provider and sends the predecoded bitstream to the decoder. In yet another exemplary embodiment, when the predecoder 1240 is located within the decoder, the predecoder 1240 truncates unnecessary bits of the bitstream in such a way as to reconstruct a video with the desired resolution and frame rate.

Various components of the above-described video encoder system 1200 and a video decoder system 1300, which will be described below, are functional modules and perform the same functions as described above. The term 'module', as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more computers in a communication system.

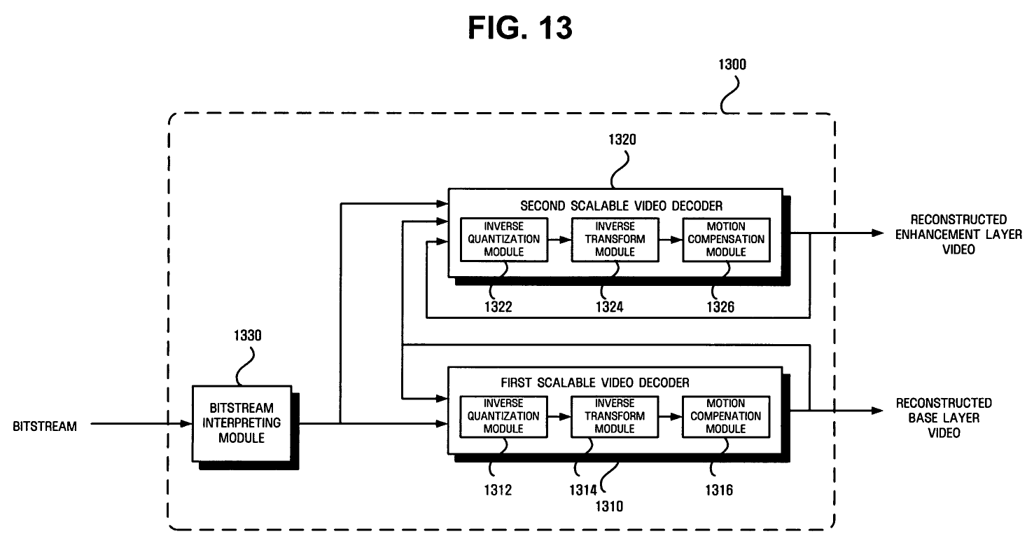

FIG. 13 is a block diagram of the video decoder system 1300 according to an exemplary embodiment of the present invention. While the video encoder system 1200 encodes video data into two layers with different resolutions, it may encode video data into n layers with different resolutions.

Referring to FIG. 13, the video decoder system 1300 includes a first scalable video decoder 1310 decoding a base layer video and a second scalable video encoder 1320 decoding an enhancement layer video. The first and second scalable video decoders 1310 and 1320 receive coded video data from the bitstream interpreting module 1330 for decoding.

The first scalable video decoder 1310 receives the encoded base layer video and decodes the same using scalable video decoding. To accomplish this, the first scalable video decoder 1310 includes an inverse quantization module 1312, an inverse transform module 1314, and a motion compensation module 1316.

The inverse quantization module 1312 applies inverse quantization to the received encoded video data and outputs transform coefficients. Currently known inverse quantization algorithms include EZW, SPIHT, EZBC, EBCOT, and so on.

In the case of an intracoded frame, the inverse transform module 1314 performs inverse transform on the transform coefficients to reconstruct the original frame. In the case of an intercoded frame, the inverse transform module 1314 performs inverse transform to produce a residual frame.

The motion compensation module 1316 compensates for motion of the residual frame using the previously reconstructed frame as a reference in order to reconstruct the original frame. Algorithms such as UMCTF or STAR may be used for the motion compensation.

The second scalable video decoder 1320 receives the encoded enhancement layer video data and decodes the same using scalable video decoding. To accomplish this, the second scalable video decoder 1320 includes an inverse quantization module 1322, an inverse transform module 1324, and a motion compensation module 1326.

The inverse quantization module 1322 applies inverse quantization to the received encoded video data and produces transform coefficients. Currently known inverse quantization algorithms include EZW, SPIHT, EZBC, EBCOT, and so on.

The inverse transform module 1324 performs inverse transform on the transform coefficients. In the case of an intracoded frame, the inverse transform module 1324 performs inverse transform on the transform coefficients to reconstruct the original frame. In the case of an intercoded frame, the inverse transform module 1324 performs inverse transform to produce a residual frame.

The motion compensation module 1326 receives a residual frame and compensates for motion of the residual frame using the previously reconstructed base layer frame and the previously reconstructed enhancement layer frame as a reference in order to reconstruct the original frame. Algorithms such as UMCTF or STAR may be used for the motion compensation.

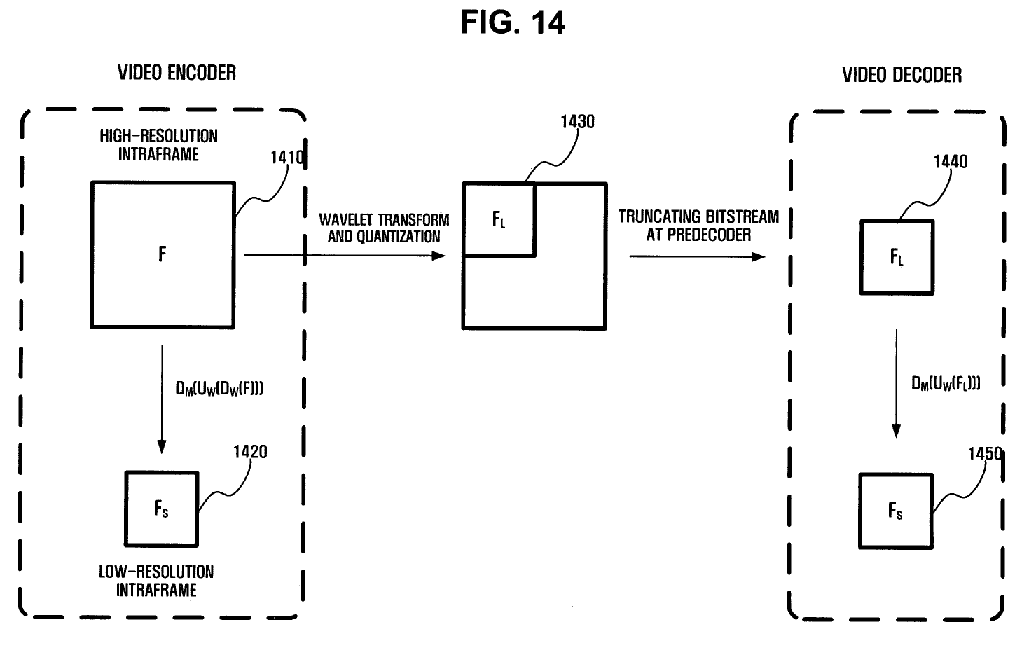

FIG. 14 is a diagram for explaining a process of generating a smooth intraframe in a smooth enhancement layer in intraframe sharing and decoding a shared intraframe. 1141 In FIG. 14, D and U respectively denote downsampling and upsampling, and subscripts W and M respectively denote wavelet- and MPEG-based schemes. F, F_{S}, F_{L} respectively represent a high-resolution (base layer) frame, a low-resolution (enhancement layer) frame, and a low-pass subband in the high-resolution frame.

In order to obtain a low-resolution bitstream, a video sequence is first downsampled to a lower resolution and then the downsampled version is upsampled to a higher resolution using a wavelet-based method, followed by MPEG-based downsampling. A low-resolution video sequence obtained by performing the MPEG-based downsampling is then encoded using scalable video coding.

When a low-resolution frame F_{S} 1420 is an intraframe, the low-resolution frame F_{S} 1420 is not contained in a bitstream but obtained from a high-resolution intraframe F 1410 contained in the bitstream. That is, to obtain the smooth low-resolution intraframe F_{S} 1420, the high-resolution intraframe F 1410 is downsampled and then upsampled using a wavelet-based scheme to obtain approximation of the original high-resolution interframe F 1410, followed by MPEG-based downsampling. The high-resolution intraframe F 1410 is subjected to wavelet transform and quantization and then combined into the bitstream. Some bits of the bitstream is truncated by a predecoder before being transmitted to a decoder. By truncating high-pass subbands of the high-resolution intraframe F 1410, a low-pass subband FL 1430 in the high-resolution intraframe F 1410 is obtained. In other words, the low-pass subband FL 1430 is a downsampled version D_{W}(F) of the high-resolution intraframe F 1410. The decoder that receives a low-pass subband F_{L} 1440 upsamples it using the wavelet-based scheme and downsamples an upsampled version using the MPEG-based scheme, producing a smooth intraframe F_{S} 1450.

As described above, in the encoding and decoding methods and systems according to the present invention, it is possible to provide video streaming services at various image qualities.

In concluding the detailed description, those skilled in the art will appreciate that many variations and modifications can be made to the exemplary embodiments without substantially departing from the principles of the present invention. Accordingly, the scope of the invention is to be construed in accordance with the following claims.

1. A video encoding method comprising:
encoding first frames having a first resolution using scalable video coding;
upsampling the first frames to a second resolution; and
encoding second frames having the second resolution using scalable video coding with reference to the first frames upsampled to the second resolution.

2. A video encoding method comprising:
encoding first frames having a first resolution using non-scalable video coding;
upsampling the first frames to a second resolution; and
encoding second frames having a second resolution using scalable video coding with reference to the first frames upsampled to the second resolution.

3. A video encoding method comprising:
encoding first frames having a first resolution using scalable video coding;
upsampling the first frames to a second resolution;
upsampling the first frames to a third resolution;
encoding second frames having the second resolution using scalable video coding with reference to the first frames upsampled to the second resolution; and
encoding third frames having the third resolution using scalable video coding with reference to the first frames upsampled to the third resolution.

4. A video encoding method comprising:
encoding first frames having a first resolution using scalable video coding;
upsampling the first frames to a second resolution;
encoding second frames having the second resolution using scalable video coding with reference to the first frames upsampled to the second resolution;
encoding third frames having a third resolution which is higher than the second resolution using scalable video coding;
upsampling the third frames to a fourth resolution; and
encoding fourth frames having the fourth resolution using scalable video coding with reference to the third frames upsampled to the fourth resolution.

5. A video encoding method comprising:
encoding first frames having a first resolution using scalable video coding;
encoding second frames having a second resolution which is higher than the first resolution, using scalable video coding, independently of the first frames; and
encoding third frames having a third resolution which is higher than the second resolution using scalable video coding, independently of the second frames.

6. A video encoding method comprising:
encoding first frames having a first resolution using non-scalable video coding;
encoding second frames having a second resolution which is higher than the first resolution using scalable video coding, independently of the first frames; and
encoding third frames having a third resolution which is higher than the second resolution using scalable video coding, independently of the second frames.

7. A video encoding method comprising:
encoding first frames having a first resolution using scalable video coding;
upsampling the first frames to a second resolution;
encoding second frames having a third resolution which is higher than the second resolution using scalable video coding;
downsampling the second frames to the second resolution; and
encoding third frames having the second resolution using scalable video coding with reference to the first resolution frames upsampled to the second resolution and the second frames downsampled to the third resolution.

8. A video encoding method comprising:
encoding first frames having a first resolution using scalable video coding;
downsampling the first frames to a second resolution; and
encoding second frames having a second resolution using scalable video coding with reference to the first frames downsampled to the second resolution.

9. A video encoding method comprising:
encoding first frames having a first resolution using scalable video coding;
downsampling the first frames to a second resolution; and
encoding second frames having a second resolution using non-scalable video coding with reference to the first frames downsampled to the second resolution.

10. A video encoding method comprising:
encoding first frames having a first resolution using scalable video coding;
downsampling the first frames to a second resolution;
encoding second frames having the second resolution using scalable video coding with reference to the first frames downsampled to the second resolution;
downsampling the first frames to a third resolution lower than the second resolution; and
encoding third frames having the third resolution using scalable video coding with reference to the first frames downsampled to the third resolution.

11. The method of claim 1, wherein if the first frames have the same frame rate as the second frames, the first frames are encoded in the same order as the second frames.

12. The method of claim 8, wherein each of the second frames has the same type as its corresponding first frame.

13. The method of claim 8, wherein if the second frames have a different frame rate than the first frames, the percentage of intraframes in the second frames is made equal to the percentage of intraframes in the first frames.

14. A video encoder system comprising:
a first scalable video encoder encoding first frames having a first resolution using non-scalable video coding;
a second scalable video encoder converting the first frames into a second resolution and encoding second frames having the second resolution using scalable video coding with reference to the first frames converted into the second resolution; and
a bitstream generating module generating a bitstream consisting of the first frames which are encoded and the second frames which are encoded.

15. The system of claim 14, wherein the first resolution frames are encoded according to an H.264 or MPEG-4 coding standard.

16. A video encoder system comprising:
a first scalable video encoder encoding first frames having a first resolution using scalable video coding;
a second scalable video encoder encoding second frames having a second resolution which is lower than the first resolution using scalable video coding; and
a bitstream generating module generating a bitstream consisting of the first frames which are encoded and the second frames which are encoded.

17. The system of claim 16, wherein the second frames are obtained by downsampling and upsampling the first frames using a wavelet-based scheme, followed by MPEG-based downsampling.

18. A video encoder system comprising:
a scalable video encoder encoding first frames having a first resolution using scalable video coding;
a non-scalable video encoder encoding frames having a second resolution which is lower than the first resolution using non-scalable video coding; and
a bitstream generating module generating a bitstream consisting of the first frames which are encoded and the second frames which are encoded.

19. The system of claim 18, wherein the second resolution frames are encoded according to an H.264 or MPEG-4 coding standard.

20. A video decoding method comprising:
decoding first frames, which have a first resolution and are encoded using scalable video coding, to reconstruct original frames;
upsampling the first frames which are reconstructed to a second resolution; and
decoding second frames, which have a second resolution and are encoded using scalable video coding, with reference to upsampled versions of the first frames which are reconstructed in order to reconstruct original frames.

21. A video decoding method comprising:
decoding first frames, which have a first resolution and are encoded using non-scalable video coding, to reconstruct original frames;
upsampling the first resolution frames which are reconstructed to a second resolution; and
decoding second frames, which have a second resolution and are encoded using scalable video coding, with reference to upsampled versions of the first frames which are reconstructed in order to reconstruct original frames.

22. A video decoding method comprising:
decoding first frames, which have a first resolution and are encoded using scalable video coding, to reconstruct original frames;
downsampling some of the first resolution frames which are reconstructed to a second resolution and generating intraframes with the second resolution; and
decoding second interframes, which have a second resolution and are encoded using scalable video coding, with reference to the intraframes which are generated.

23. A video decoding method comprising:
decoding first frames, which have a first resolution and are encoded using scalable video coding, to reconstruct original frames;
downsampling some of the first resolution frames which are reconstructed to a second resolution and generating intraframes with the second resolution; and
decoding second interframes, which have the second resolution and are encoded using non-scalable video coding, with reference to the intraframes which are generated.

24. A video decoder system comprising:
a first scalable video decoder decoding first frames, which have a first resolution and are encoded using scalable video coding, in order to reconstruct original frames; and
a second scalable video decoder converting the first frames which are reconstructed to a second resolution and decoding second frames, which have the second resolution and are encoded using scalable video coding, with reference to the first frames which are converted in order to reconstruct original frames.

25. A video decoder system comprising:
a non-scalable video decoder decoding first frames, which have a first resolution and are encoded using non-scalable video coding, in order to reconstruct original frames; and
a scalable video decoder converting the first frames which are reconstructed to a second resolution and decoding second frames, which have the second resolution and are encoded using scalable video coding, with reference to the first frames which are converted in order to reconstruct original frames.
